(19) United States
(12) Patent Application Publication
(10) Pub. No.: US 2024/0322151 A1
(43) Pub. Date: Sep. 26, 2024

(54) ELECTRODE MATERIAL, ELECTRODE, AND BATTERY

(71) Applicant: Panasonic Intellectual Property Management Co., Ltd., Osaka (JP)

(72) Inventors: Tomokatsu WADA, Osaka (JP); Akihiko SAGARA, Nara (JP)

(21) Appl. No.: 18/733,260

(22) Filed: Jun. 4, 2024

Related U.S. Application Data
(63) Continuation of application No. PCT/JP2022/044443, filed on Dec. 1, 2022.

(30) Foreign Application Priority Data
Dec. 10, 2021 (JP) 2021-201136

(51) Int. Cl. H01M 4/485; H01M 4/02; H01M 4/131; H01M 10/0562

(52) U.S. Cl. CPC H01M 4/485; H01M 4/131; H01M 10/0562; H01M 2004/027; H01M 2004/028; H01M 2300/008

(57) ABSTRACT

An electrode material according to the present disclosure includes an active material, a first solid electrolyte, and a second solid electrolyte. The first solid electrolyte includes I, the second solid electrolyte is free of I, and a volume ratio representing a volume of the first solid electrolyte to a sum of the volume of the first solid electrolyte and a volume of the second solid electrolyte is 1% or more and 49% or less. The electrode material may further include a binder.

This application is a continuation of PCT/JP2022/044443 filed on Dec. 1, 2022, which claims foreign priority of Japanese Patent Application No. 2021-201136 filed on Dec. 10, 2021, the entire contents of both of which are incorporated herein by reference.

### BACKGROUND OF THE INVENTION

### 1. Field of the Invention

The present disclosure relates to an electrode material, an electrode, and a battery.

### 2. Description of Related Art

WO2019/146295 discloses a negative electrode material that has a negative electrode active material including lithium titanate and a solid electrolyte including a halide, and an all-solid-state battery using the same.

### SUMMARY OF THE INVENTION

The present disclosure provides an electrode material suitable for improving effective ionic conductivity of an electrode.

An electrode material of the present disclosure includes:
an active material;
a first solid electrolyte; and
a second solid electrolyte,
wherein the first solid electrolyte includes I,
the second solid electrolyte is free of I, and
a ratio of a volume of the first solid electrolyte to a sum of the volume of the first solid electrolyte and a volume of the second solid electrolyte is 1% or more and 49% or less.

The present disclosure provides an electrode material suitable for improving effective ionic conductivity of the electrode.

### BRIEF DESCRIPTION OF THE DRAWINGS

FIG. 1 is a cross-sectional view schematically showing an electrode material according to First Embodiment.

FIG. 2 is a cross-sectional view schematically showing an electrode according to Second Embodiment.

FIG. 3 is a graph showing a relationship between a volume ratio of first solid electrolyte and effective ionic conductivity of electrode for Inventive Example and Comparative Examples.

### DETAILED DESCRIPTION

(Finding Knowledge that Forms Basis of the Present Disclosure)

Electrodes that include conventional electrode materials including solid electrolytes tend to have low effective ionic conductivity. After an extensive research, the present inventors have newly discovered that it is possible to improve effective ionic conductivity of an electrode by using two types of solid electrolytes with compositions different from each other. The present inventors conducted further studies based on the new findings and completed the electrode material of the present disclosure.

(Overview of one aspect of the present disclosure)

An electrode material of the present disclosure includes:
an active material;
a first solid electrolyte; and
a second solid electrolyte,
wherein the first solid electrolyte includes I,
the second solid electrolyte is free of I, and
a ratio of a volume of the first solid electrolyte to a sum of the volume of the first solid electrolyte and a volume of the second solid electrolyte is 1% or more and 49% or less.

The electrode material according to the first aspect is capable of improving effective ionic conductivity of the electrode.

As to a second aspect of the present disclosure, for example in the electrode material according to the first aspect, the ratio may be 20% or more and 30% or less.

The electrode material according to the second aspect is capable of further improving effective ionic conductivity of the electrode.

As to a third aspect of the present disclosure, for example in the electrode material according to the first or second aspect, the first solid electrolyte may include a compound represented by a composition formula (1) below:

Li_{α1}Ml_{β1}X1_{γ1}|_{δ1} Formula (1)

in the composition formula (1),

α1 satisfies 0<α1,

β1 satisfies 0<β1,

γ1 satisfies 0≤γ1,

δ1 satisfies 0<δ1,

M1 includes at least one selected from the group consisting of metalloid elements and metal elements other than Li, and

X1 includes at least one selected from the group consisting of F, Cl, and Br.

The electrode material according to the third aspect is capable of further improving effective ionic conductivity of the electrode.

As to a fourth aspect of the present disclosure, for example in the electrode material according to the third aspect, the M1 may include Y The electrode material according to the fourth aspect is capable of further improving effective ionic conductivity of the electrode.

As to a fifth aspect of the present disclosure, for example in the electrode material according to the fourth aspect, the first solid electrolyte may include a compound represented by a composition formula (1A) below:

Li_{α1}Y_{β1}Br_{γ1a}Cl_{γ1b}|_{δ1} Formula (1A)

in the composition formula (1A),

α1 satisfies 2.5≤α1≤3.5,

β1 satisfies 0.5≤B1≤1.5,

γ1a satisfies 0≤γ1a<6,

γ1b satisfies 0≤γ1b<6,

δ1 satisfies 0<δ1<6, and

γ1a+γ1b+δ1=6 is satisfied.

The electrode material according to the fifth aspect is capable of further improving effective ionic conductivity of the electrode.

As to a sixth aspect of the present disclosure, for example regarding the electrode material according to the fifth aspect, in the composition formula (1A),

α1=3, β1=1, 0<γ1a<6,0<γ1b<6, and 0<δ1<6 may be satisfied.

The electrode material according to the sixth aspect is capable of further improving effective ionic conductivity of the electrode.

As to a seventh aspect of the present disclosure, for example in the electrode material according to any one of the first to the sixth aspect, the second solid electrolyte may include a compound represented by a composition formula (2) below:

Li_{α2}M2_{β2}X2_{γ2} Formula (2)

in the composition formula (2),

α2 satisfies 0<α2,

β2 satisfies 0<β2,

γ2 satisfied 0<γ2,

M2 includes at least one selected from the group consisting of metalloid elements and metal elements other than Li, and

X2 includes at least one selected from the group consisting of F, Cl, and Br.

The electrode material according to the seventh aspect is capable of further improving effective ionic conductivity of the electrode.

As to an eighth aspect of the present disclosure, for example in the electrode material according to the seventh aspect, M2 may include Y The electrode material according to the eighth aspect is capable of further improving effective ionic conductivity of the electrode.

As to a ninth aspect of the present disclosure, for example in the electrode material according to the eighth aspect, the second solid electrolyte may include a compound represented by a composition formula (2A) below:

Li_{α2}Y_{β2}Br_{γ2a}C_{lγ2b} Formula (2A)

in the composition formula (2A),

α2 satisfies 2.5≤α2≤3.5,

β2 satisfies 0.5≤β2≤1.5,

γ2a satisfies 0≤γ2a<6,

γ2b satisfies 0≤γ2b≤6, and

γ2a+γ2b=6 is satisfied.

The electrode material according to the ninth aspect is capable of further improving effective ionic conductivity of the electrode.

As to a tenth aspect of the present disclosure, for example, regarding the electrode material according to the ninth aspect, in the composition formula (2A), α2=3, β2=1, 0<γ2a<6, and 0<γ2b<6, are satisfied.

The electrode material according to the tenth aspect is capable of further improving effective ionic conductivity of the electrode.

As to an eleventh aspect of the present disclosure, for example, the electrode material according to any one of the first to the tenth aspects may further include a binder.

The electrode material according to the eleventh aspect is capable of improving the binding properties of the materials constituting the electrode material, since the electrode material includes a binder.

As to a twelfth aspect of the present disclosure, for example in the electrode material according to the eleventh aspect, the binder may be a polymer.

The electrode material according to the twelfth aspect is capable of further improving binding properties of the materials constituting the electrode material.

As to a thirteenth aspect of the present disclosure, for example in the electrode material according to the twelfth aspect, the polymer may include a thermoplastic elastomer.

The electrode material according to the thirteenth aspect is capable of further improving binding properties of the materials constituting the electrode material.

A battery according to a fourteenth aspect of the present disclosure includes:
a first electrode,
a second electrode, and
an electrolyte layer located between the first electrode and the second electrode, wherein the first electrode includes the electrode material according to any one of the first to the thirteenth aspects.

The battery according to the fourteenth aspect is capable of improving effective ionic conductivity of the first electrode.

As to a fifteenth aspect of the present disclosure, for example in the battery according to the fourteenth aspect, the electrolyte layer may include a solid electrolyte.

According to the fifteenth aspect, a solid-state battery can be provided.

As to a sixteenth aspect of the present disclosure, for example in the battery according to the fourteenth or fifteenth aspect, the active material included in the first electrode may include lithium titanate.

The battery according to the sixteenth aspect is capable of improving effective ionic conductivity of the first electrode.

As to a seventeenth aspect of the present disclosure, for example in the battery according to any one of the fourteenth to the sixteenth aspects, the first electrode may be a negative electrode and the second electrode may be a positive electrode.

The battery according to the seventeenth aspect is capable of improving effective ionic conductivity of the negative electrode.

An electrode according to an eighteenth aspect of the present disclosure is an electrode including:
an active material;
a first solid electrolyte; and
a second solid electrolyte,
wherein the first solid electrolyte includes I,
the second solid electrolyte is free of I, and
an area ratio representing an area of the first solid electrolyte to a sum of the area of the first solid electrolyte and an area of the second solid electrolyte in a cross section of the electrode is 1% or more and 49% or less.

The electrode according to the eighteenth aspect is capable of having improved effective ionic conductivity.

As to a nineteenth aspect of the present disclosure, for example in the electrode according to the eighteenth aspect, the ratio may be 20% or more and 30% or less.

The electrode according to the nineteenth aspect can have a further improved effective ionic conductivity.

A battery according to a twentieth aspect of the present disclosure includes:
a first electrode;
a second electrode; and
an electrolyte layer located between the first electrode and the second electrode, wherein the first electrode is the electrode according to the eighteenth or nineteenth aspect.

The battery according to the twentieth aspect is capable of improving effective ionic conductivity of the first electrode.

(Embodiments of the present disclosure)

Embodiments of the present disclosure will be explained below with reference to the attached drawings.

### First Embodiment

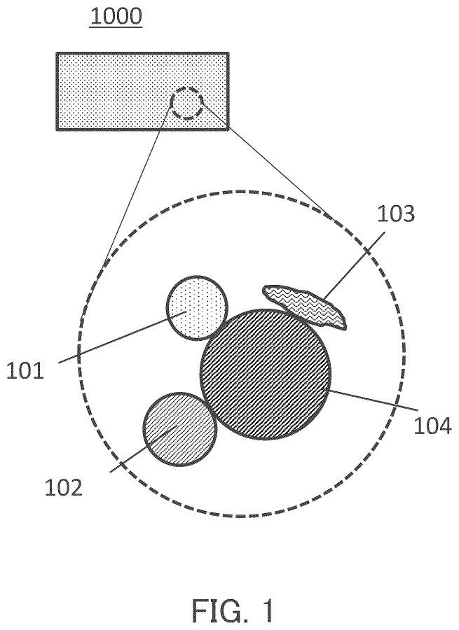

FIG. 1 is a cross-sectional view schematically showing an electrode material according to First Embodiment.

An electrode material 1000 according to the First Embodiment includes a first solid electrolyte 101, a second solid electrolyte 102, and an active material 104. The electrode material 1000 may further include a binder 103. The first solid electrolyte 101 includes I. The second solid electrolyte 102 is free of I. A volume ratio representing a volume of the first solid electrolyte 101 to a sum of the volume of the first solid electrolyte 101 and a volume of the second solid electrolyte 102 is 1% or more and 49% or less.

Hereinafter, the ratio will be referred to as the “volume ratio R1”. Volume V1 of the first solid electrolyte 101 and volume V2 of the second solid electrolyte 102 can be determined by the following method. First, a cross section of the electrode material 1000 or an electrode including the electrode material 1000 is observed using a scanning electron microscope (SEM). In the obtained SEM image, for example, a solid electrolyte present within an area of 50 μm length and 100 μm width is identified. For the identified solid electrolyte, areas of the first solid electrolyte 101 and the second solid electrolyte 102 are determined from distribution of I by element mapping using energy dispersive X-ray spectroscopy (EDS). Based on the identified areas of the first solid electrolyte 101 and the second solid electrolyte 102, a graph showing the volume ratio R1 of the first solid electrolyte 101 is created. In other words, the volume V1 of the first solid electrolyte 101 and the volume V2 of the second solid electrolyte 102 can be identified by regarding an area A1 of the first solid electrolyte 101 and an area A2 of the second solid electrolyte 102 as volumes, where both of the areas are calculated using the cross section of the electrode material 1000. Using the volumes V1 and V2 identified in this way, the volume ratio R1 can be determined.

The volume V1 of the first solid electrolyte 101 and the volume V2 of the second solid electrolyte 102 for calculating the volume ratio R1 are determined from the volumes of the first solid electrolyte 101 and the second solid electrolyte 102, both of which are used as raw materials for producing the electrode material 1000.

The volume ratio R1 may be 20% or more and 30% or less.

The first solid electrolyte 101 including I as a constituent element tends to have higher ionic conductivity as a material in comparison with the second solid electrolyte 102 free of I as a constituent element. On the other hand, the second solid electrolyte 102 tends to exhibit higher effective ionic conductivity than the first solid electrolyte 101, in a state of an electrode prepared by mixing with the binder 103, for example. Therefore, effective ionic conductivity can be improved by setting the first solid electrolyte 101 and the second solid electrolyte 102 to an appropriate volume ratio R1. As described above, the electrode material 1000 according to the First Embodiment has a configuration satisfying a requirement that the volume ratio R1 is 1% or more and 49% or less. With this configuration, the electrode material 1000 according to the First Embodiment can improve the effective ionic conductivity of the electrode.

In the present embodiment, the first solid electrolyte 101 and the second solid electrolyte 102 have lithium ion conductivity, for example. The first solid electrolyte 101 and the second solid electrolyte 102 may include a halide solid electrolyte. In the present disclosure, “halide solid electrolyte” means a solid electrolyte that includes a halogen element while being free of sulfur. In the present disclosure, a solid electrolyte free of sulfur means a solid electrolyte expressed by a composition formula that does not include a sulfur element. Therefore, a solid electrolyte including a very small amount of sulfur component, for example, a solid electrolyte including 0.1% by mass or less of sulfur, is included in a solid electrolyte free of sulfur. The halide solid electrolyte may further include oxygen as an anion other than the halogen element.

The first solid electrolyte 101 includes, for example, Li, M1, X1, and I. M1 includes at least one selected from the group consisting of metalloid elements and metal elements other than Li. X1 includes at least one selected from the group consisting of F, Cl, and Br.

The first solid electrolyte 101 may substantially consist of Li, M1, X1, and I. The expression “first solid electrolyte 101 substantially consists of Li, M1, X1, and I” means that in the first solid electrolyte 101, the ratio of the sum of the amounts of substance of Li, M1, X1, and I to the sum of the amounts of substance of all the elements constituting the first solid electrolyte 101 (mole fraction) is 90% or more. As an example, the ratio may be 95% or more. The first solid electrolyte 101 may consist of Li, M1, X1, and I.

The second solid electrolyte 102 includes, for example, Li, M2, and X2. M2 includes at least one selected from the group consisting of metalloid elements and metal elements other than Li. X2 includes at least one selected from the group consisting of F, Cl, and Br.

The second solid electrolyte 102 may substantially consist of Li, M2, and X2. The expression “second solid electrolyte 102 substantially consists of Li, M2, and X2” means that in the second solid electrolyte 102, a ratio of the sum of the amounts of substance of Li, M2, and X2 to the sum of the amounts of substance of all the elements constituting the second solid electrolyte 102 (mole fraction) is 90% or more. As an example, the ratio may be 95% or more. The second solid electrolyte 102 may consist of Li, M2, and X2.

Hereinafter, M1 and M2 may be collectively referred to as simply “M”. Further, X1 and X2 may be collectively referred to as simply “X”.

In order to enhance ionic conductivity, M may include at least one selected from the group consisting of Group 1 elements, Group 2 elements, Group 3 elements, Group 4 elements, and lanthanoid elements. M may include at least one selected from the group consisting of Group 5 elements, Group 12 elements, Group 13 elements, and Group 14 elements.

Examples of the Group 1 elements include Na, K, Rb, and Cs. Examples of the Group 2 elements include Mg, Ca, Sr, and Ba. Examples of the Group 3 elements include Sc and Y Examples of the Group 4 elements include Ti, Zr, and Hf. Examples of the lanthanoid elements include La, Ce, Pr, Nd, Sm, Eu, Gd, Tb, Dy, Ho, Er, Tm, Yb, and Lu. Examples of the Group 5 elements include Nb and Ta. Examples of the Group 12 elements include Zn. Examples of the Group 13 elements include Al, Ga, and In. And, examples of the Group 14 elements include Sn.

To further enhance the ionic conductivity, M may include at least one selected from the group of Na, K, Mg, Ca, Sr, Ba, Sc, Y, Zr, Hf, La, Ce, Pr, Nd, Sm, Eu, Gd, Tb, Dy, Ho, Er, Tm, Yb and Lu.

To further enhance the ionic conductivity, M may include at least one selected from the group of Mg, Ca, Sr, Y, Sm, Gd, Dy and Hf. The M may include Y

To further enhance the ionic conductivity, X may include at least one selected from the group of Br and Cl.

To further enhance the ionic conductivity, X may include Br and Cl.

The first solid electrolyte 101 may include a compound represented by a composition formula (1) below:

Li_{α1}M1_{β1}X1_{γ1}|_{δ1} Formula (1)

in the composition formula (1), the following mathematical formulae may be satisfied: 0<α1, 0<β1, 0≤γ1, and 0<δ1.

Since the first solid electrolyte 101 includes the compound represented by the composition formula (1), the electrode material 1000 according to the First Embodiment is capable of further improving effective ionic conductivity of the electrode.

The first solid electrolyte 101 may be a compound represented by the composition formula (1).

In the composition formula (1), M1 may include yttrium (Y). With this configuration, the electrode material 1000 according to the First Embodiment is capable of further improving effective ionic conductivity of the electrode.

In order to further improve the effective ionic conductivity of the electrode, M1 may be Y in the above composition formula (1). The first solid electrolyte 101 may include, for example, Li₃YX1_{γ1}|_{δ1}, and in this case, γ1+δ1=6 may be satisfied.

The first solid electrolyte 101 may include a compound represented by the following composition formula (1A):

Li_{α1}Y_{β1}Br_{γ1a}Cl_{γ1b}|_{δ1} Formula (1A)

in the composition formula (1A), the following mathematical formulae may be satisfied:
2.5≤α1<3.5,
0.5≤β1≤1.5,
0≤γ1a<6,
0 s γ1b<6,
0<51<6, and
γ1a+γ1b+δ1=6.

Since the first solid electrolyte 101 includes the compound represented by the composition formula (1A), the electrode material 1000 according to the First Embodiment is capable of further improving effective ionic conductivity of the electrode.

In order to further improve the effective ionic conductivity of the electrode, in the composition formula (1A), the following mathematical formulae may be satisfied: α1=3, β1=1, 0<γ1a<6, 0<γ1b<6, and 0<51<6. That is, the first solid electrolyte 101 may include Li₃YBr_{γ1a}Cl_{γ1b}|_{δ1}.

The first solid electrolyte 101 may be a compound represented by the composition formula (1A).

The first solid electrolyte 101 may include, for example, Li₃YBr₂Cl₂I₂ or it may be Li₃YBr₂Cl₂I₂.

The first solid electrolyte 101 may include plural types of compounds having compositions different from each other, or may be composed of one type of compound.

However, as described above, the compound constituting the first solid electrolyte 101 includes I as a constituent element.

The second solid electrolyte 102 may include a compound represented by the composition formula (2) below:

Li_{α2}M2_{β2}X2_{γ2} Formula (2)

In the composition formula (2), the following mathematical formulae may be satisfied: 0<α2, 0<β2, and 0<γ2.

Since the second solid electrolyte 102 includes the compound represented by the composition formula (2), the electrode material 1000 according to the First Embodiment is capable of further improving effective ionic conductivity of the electrode.

The second solid electrolyte 102 may be a compound represented by the composition formula (2).

In the composition formula (2), M2 may include Y With this configuration, the electrode material 1000 according to the First Embodiment is capable of further improving effective ionic conductivity of the electrode.

In order to further improve the effective ionic conductivity of the electrode, M1 in the composition formula (2) may be Y The second solid electrolyte 102 may include, for example, Li₃YX2_{γ2}, or it may include Li₃YX2₆.

The second solid electrolyte 102 may include a compound represented by a composition formula (2A) below.

Li_{α2}Y_{β2}Br_{γ2a}Cl_{γ2b} Formula (2A)

In the composition formula (2A), the following mathematical formulae may be satisfied:
2.5≤α2≤3.5,
0.5≤β2≤1.5,
0≤γ2a<6,
0≤γ2b≤6, and
γ2a+γ2b=6.

Since the second solid electrolyte 102 includes the compound represented by the composition formula (2A), the electrode material 1000 according to the First Embodiment is capable of further improving effective ionic conductivity of the electrode.

In order to further improving effective ionic conductivity of the electrode, the following mathematical formulae may be satisfied in the composition formula (2A): α2=3, P2=1, 0<γ2a<6, and 0<γ2b<6.

That is, the second solid electrolyte 102 may include Li₃YBr_{γ2a}Cl_{γ2b}.

The second solid electrolyte 102 may be a compound represented by the composition formula (2A).

The second solid electrolyte 102 may include Li₃YBr₆ or Li₃YBr_{X}Cl₆₋ₓ.

Here, x satisfies 0<x<6.

The second solid electrolyte 102 may include at least one selected from the group consisting of Li₃YBr₆ and Li₃YBr₂Cl₄, or may include Li₃YBr₂Cl₄. The second solid electrolyte 102 may be Li₃YBr₂Cl₄.

The second solid electrolyte 102 may include plural types of compounds having compositions different from each other, or it may be composed of one type of compound. However, as described above, the compound constituting the second solid electrolyte 102 does not include I as a constituent element.

The shapes of the first solid electrolyte 101 and the second solid electrolyte 102 are not limited. The shapes of the first solid electrolyte 101 and the second solid electrolyte 102 may be, for example, acicular, spherical, ellipsoidal, fibrous or the like.

The first solid electrolyte 101 and the second solid electrolyte 102 may be particulate. In a case where the first solid electrolyte 101 and the second solid electrolyte 102 are particulate, the average particle diameter D1 of the first solid electrolyte 101 and the average particle diameter D2 of the second solid electrolyte 102 may be smaller than the average particle diameter D4 of the active material 104. In this case, since the number of particles of the first solid electrolyte 101 and the second solid electrolyte 102 in contact with the active material is sufficiently large, a decline in lithium ion conductivity within the electrode material 1000 is prevented or reduced. Therefore, in a battery using this electrode material 1000, degradation in charge-discharge characteristics is prevented or reduced. As an example, the average particle diameter D1 of the first solid electrolyte 101 and the average particle diameter D2 of the second solid electrolyte 102 may be 1.5 μm or less.

The average particle diameter D1 of the first solid electrolyte 101 and the average particle diameter D2 of the second solid electrolyte 102 can be determined by the following method. First, the cross section of the electrode material 1000 or the electrode including the electrode material 1000 is observed using a SEM. In the obtained SEM image, for example, the first solid electrolyte 101 and the second solid electrolyte 102 that are present within a range of 50 μm in length and 100 μm in width are identified. The area of each identified solid electrolyte is determined from the distribution of I by EDS mapping. For each of the identified first solid electrolyte 101 and second solid electrolyte 102, the area is determined by image processing. Next, the diameter of a circle with an area equal to the identified area is calculated. The calculated diameters can be regarded as the particle diameter d1 of first solid electrolyte 101 and the particle diameter d2 of second solid electrolyte 102. Furthermore, the volume of the sphere with the calculated diameter can be regarded as the volume V1 of the first solid electrolyte 101 and the volume V2 of the second solid electrolyte 102. Based on the particle diameters d1 and d2 and the volumes V1 and V2, a graph showing the particle size distribution of first solid electrolyte 101 and second solid electrolyte 102 each will be created. The particle size distributions of the first solid electrolyte 101 and the second solid electrolyte 102 each tend to have one peak. The particle diameter corresponding to the top of this peak can be regarded as the average particle diameter D1 of the first solid electrolyte 101 or the average particle diameter D2 of the second solid electrolyte 102.

The binder 103 may be a polymer.

The polymer used as the binder 103 may include a thermoplastic elastomer. The thermoplastic elastomer may have a polystyrene skeleton and a polyethylene skeleton.

The active material 104 may include lithium titanate.

The active material 104 may include at least one selected from the group consisting of Li₄Ti₅O₁₂, Li₇Ti₅O₁₂, and LiTi₂O₄, or it may include Li₄Ti₅O₁₂.

The active material 104 is not limited to the above examples. The active material may further include M3. The M3 is at least one selected from the group consisting of metalloid elements and metal elements other than Li and Ti.

In the present disclosure, the term “metal elements” refers to (i) all elements included in Groups 1 to 12 of the periodic table, excluding hydrogen; and (ii) all elements included in Groups 13 to 16 of the periodic table, excluding B, Si, Ge, As, Sb, Te, C, N, P, O, S, and Se. That is, each of the metal elements belongs to a group of elements that can become a cation when the metal forms an inorganic compound with a halogen element.

In the present disclosure, the term “metalloid elements” refers to B, Si, Ge, As, Sb, and Te.

The active material may include Zr (i.e., zirconium) as M3. The active material may be represented by a composition formula (3) below.

Li₄Ti_{5-α3}Zr_{α3}O₁₂ Formula (3)

Here, a satisfies 0<α3≤0.3.

In the composition formula (3), a may satisfy 0<α3≤0.2, or may satisfy 0.01≤α3≤0.1.

The active material including Zr may include a compound represented by a composition formula of Liₐ₁Ti_{b1}Zr_{c1}Me1_{d1}Oₑ₁, for example. Here, a1+4b1+4c1+md1=2e1 and c1>0 are satisfied. Mel is at least one selected from the group consisting of metalloid elements and metal elements other than Li and Y In the formula, m is the valence of Mel. As the Mel, at least one selected from the group consisting of Mg, Ca, Sr, Ba, Zn, Sc, Al, Ga, Bi, Hf, Sn, Ta, and Nb may be used.

In the electrode material 1000 in the First Embodiment, the first solid electrolyte 101, the second solid electrolyte 102, the binder 103, and the active material 104 may be in contact with each other, as shown in FIG. 1.

Next, a method for manufacturing the first solid electrolyte 101 and the second solid electrolyte 102 will be described. The first solid electrolyte 101 and the second solid electrolyte 102 are manufactured, for example, by a method described below.

First, a raw material powder is prepared to be a desired composition ratio. The raw material powder may be a halide, for example. In a case of producing Li₃YBr₂Cl₄, for example, LiBr, LiCl, and YCl₃ are prepared at a molar ratio of LiBr:LiCl:YCl₃=2.0:1.0:1.0. The raw material powders may be mixed at a previously adjusted molar ratio so as to offset compositional changes that may occur during the synthesis process.

The types of raw material powder are not limited to the above example. For example, a combination of LiCl and YBr₃ and a complex anionic compound such as LiBr_{0.5}Cl_{0.5} may be used. A mixture of a raw material powder containing oxygen and a halide may be used. Examples of the raw material powder containing oxygen include an oxide, a hydroxide, a sulfate, and a nitrate. Examples of the halide include an ammonium halide.

The raw material powders are thoroughly mixed using a mortar and pestle, a ball mill, or a mixer to obtain a mixed powder. Next, the raw material powder is ground using a mechanochemical milling method. In this way, the raw material powders react, and the first solid electrolyte 101 and the second solid electrolyte 102 are obtained. Alternatively, the first solid electrolyte 101 and the second solid electrolyte 102 may be obtained by thoroughly mixing the raw material powders and then firing the mixed powder in a vacuum or an inert atmosphere. The firing may be performed, for example, at a temperature of 100° C. or higher and 650° C. or lower for 1 hour or longer.

As a result, the first solid electrolyte 101 and the second solid electrolyte 102 including a crystal phase are obtained.

Note that the structure of the crystal phase (that is, the crystal structure) in the first solid electrolyte 101 and the second solid electrolyte 102 can be determined by selecting the reaction method and reaction conditions between the raw material powders.

The electrode material 1000 may include a binder 103 for the purpose of improving adhesion between particles. The binder 103 is used to improve the binding properties of the materials constituting the electrode material 1000. The binder 103 may be a polymer.

Examples of the binder 103 include: polyvinylidene fluoride, polytetrafluoroethylene, polyethylene, polypropylene, aramid resin, polyamide, polyimide, polyamideimide, polyacrylonitrile, polyacrylic acid, methyl polyacrylate ester, ethyl polyacrylate ester, hexyl polyacrylate ester, polymethacrylic acid, methyl polymethacrylate ester, ethyl polymethacrylate ester, hexyl polymethacrylate ester, polyvinyl acetate, polyvinylpyrrolidone, polyether, polyethersulfone, hexafluoropolypropylene, styrene butadiene rubber, or carboxymethylcellulose. Further, as the binder 103, a copolymer of two or more kinds of materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene, can be used. These materials may be used alone or two or more thereof may be used in combination.

As the binder 103, an elastomer may be used. Elastomer means a polymer that has elasticity. The elastomer used as the binder 103 may be a thermoplastic elastomer or a thermosetting elastomer. The binder 103 may include a thermoplastic elastomer. Examples of elastomer include: a styrene-ethylene/butylene-styrene block copolymer (SEBS), a styrene-ethylene/propylene-styrene block copolymer (SEPS), a styrene-ethylene/ethylene/propylene-styrene block copolymer (SEEPS), a butylene rubber (BR), an isoprene rubber (IR), a chloroprene rubber (CR), an acrylonitrile-butadiene rubber (NBR), a styrene-butylene rubber (SBR), a styrene-butadiene-styrene block copolymer (SBS), a styrene-isoprene-styrene block copolymer (SIS), a hydrogenated isoprene rubber (HIR), a hydrogenated butyl rubber (HIIR), a hydrogenated nitrile rubber (HNBR), and a hydrogenated styrene-butylene rubber (HSBR). As the binder 103, two or more selected from these may be used as a mixture.

As described above, the polymer used as the binder 103 may include thermoplastic elastomer. The thermoplastic elastomer may have, for example, a polystyrene skeleton and a polyethylene skeleton, such as a styrene-ethylene/butylene-styrene block copolymer (SEBS).

The electrode material 1000 may include a conductive agent for the purpose of increasing electronic conductivity. As the conductive agent, for example, the following can be used:
(i) graphites such as natural graphite or artificial graphite,
(ii) carbon blacks such as acetylene black or ketjen black,
(iii) conductive fibers such as carbon fibers or metal fibers,
(iv) carbon fluorides,
(v) powder of metals such as aluminum,
(vi) conductive whiskers such as zinc oxide or potassium titanate,
(vii) conductive metal oxides such as titanium oxide, and
(viii) conductive polymer compounds such as polyaniline, polypyrrole, or polythiophene.

In a case where a carbon conductive agent is used, cost reduction can be achieved.

### Second Embodiment

A battery according to Second Embodiment of the present disclosure will be described below. Descriptions that overlap with those of the First Embodiment described above will be omitted as appropriate.

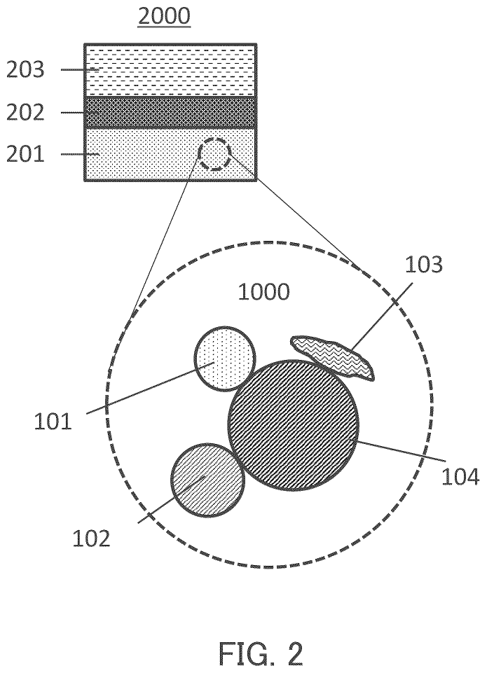

FIG. 2 is a cross-sectional view schematically showing a battery according to the Second Embodiment.

A battery 2000 according to the Second Embodiment includes a first electrode 201, a second electrode 203, and an electrolyte layer 202 located between the first electrode 201 and the second electrode 203. The first electrode 201 includes the electrode material 1000 according to the aforementioned First Embodiment.

The battery 2000 according to the Second Embodiment has the above-described configuration, so that the effective ionic conductivity of the first electrode 201 can be improved.

The first electrode 201 including the electrode material 1000 may have the following configuration:
an electrode including
an active material 104;
a first solid electrolyte 101; and
a second solid electrolyte 102,
wherein the first solid electrolyte 101 includes I,
the second solid electrolyte 102 is free of I, and
an area ratio representing an area of the first solid electrolyte 101 to a sum of the area of the first solid electrolyte 101 and an area of the second solid electrolyte 102 is 1% or more and 49% or less.

In the electrode having the configuration that the first electrode 201 may have, an area ratio representing an area of the first solid electrolyte 101 to a sum of the area of the first solid electrolyte 101 and an area of the second solid electrolyte 102 is 20% or more and 30% or less.

The first electrode 201 may further include a binder 103.

Note that the first solid electrolyte 101, the second solid electrolyte 102, the active material 104, and the binder 103 are as described the First Embodiment. The method for determining an area ratio representing an area of the first solid electrolyte 101 to a sum of the area of the first solid electrolyte 101 and an area of the second solid electrolyte 102 in the cross section of the electrode is as explained in the First Embodiment.

In the battery 2000 according to the Second Embodiment, the second electrode 203 may also include the electrode material 1000 in the above-described First Embodiment.

Hereinafter, the battery 2000 according to the Second Embodiment will be described, using an example in which the first electrode 201 is a negative electrode and the second electrode 203 is a positive electrode. Namely, as shown in FIG. 2, the negative electrode 201 in the battery 2000 according to the Second Embodiment includes the electrode material 1000 of the First Embodiment. A battery 2000 in which the negative electrode 201 includes the electrode material 1000 will be described below, though the battery 2000 in the Second Embodiment is not limited to the following embodiment. As to the battery 2000, the positive electrode 203 may include, as a first electrode, the electrode material 1000 in the above-mentioned First Embodiment.

As described above, as to the battery 2000 according to the Second Embodiment, the negative electrode 201 includes the electrode material 1000 according to the First Embodiment. Therefore, the negative electrode 201 includes the active material 104, the first solid electrolyte 101, and the second solid electrolyte 102. As explained in the First Embodiment, the active material 104 includes, for example, lithium titanate.

The negative electrode 201 is a stratum, for example. As an example, the negative electrode 201 is a single layer. The negative electrode 201 may have a thickness of 10 μm or more and 500 μm or less. In a case where the thickness of the negative electrode 201 is 10 μm or more, sufficient energy density for the battery 2000 can be ensured. In a case where the thickness of the negative electrode 201 is 500 μm or less, the battery 2000 can operate at high output.

The electrolyte layer 202 is a layer including an electrolyte material. Examples of the electrolyte material include a solid electrolyte. That is, the electrolyte layer 202 may be a solid electrolyte layer including a solid electrolyte. The electrolyte layer 202 may be formed of a solid electrolyte.

Examples of the solid electrolyte included in the electrolyte layer 202 include a halide solid electrolyte, a sulfide solid electrolyte, an oxide solid electrolyte, a polymer solid electrolyte, and a complex hydride solid electrolyte.

As the halide solid electrolyte, for example, materials exemplified as the first solid electrolyte 101 or the second solid electrolyte 102 described above may be used.

As the sulfide solid electrolyte, for example, Li₂S—P₂S₅, Li₂S—SiS₂, Li₂S—B₂S₃, Li₂S-GeS2, Li_{3.25}Ge_{0.25}P_{0.75}S₄, or Li₁₀GeP₂S₁₂ may be used. To these elements, LiX, Li₂O, MO_{q}, LiₚMO_{q} or the like may be added. The element X in “LiX” is at least one selected from the group consisting of F, Cl, Br and I. The element M in “MO_{q}” and “LiₚMO_{q}” is at least one selected from the group consisting of P, Si, Ge, B, Al, Ga, In, Fe, and Zn. In “MO_{q}“and” LiₚMO_{q}”, p and q are each independently natural numbers.

As the oxide solid electrolyte, for example, the followings may be used:
(i) a NASICON solid electrolyte such as LiTi₂(PO₄)₃ and its element substitution products,
(ii) a (LaLi)TiO₃-based perovskite solid electrolyte,
(iii) a LISICON solid electrolyte such as Li₁₄ZnGe₄O₁₆, Li₄SiO₄, or LiGeO₄ and their element substitution products,
(iv) a garnet solid electrolyte such as Li₇La₃Zr₂O₁₂ and its element substitution products,
(v) Li₃N and its H substitution products,
(vi) Li₃PO₄ and its N substitution products,
(vii) glass using a Li—B—O compound such as LiBO₂ or Li₃BO₃ as the base thereof to which Li₂SO₄ or Li₂CO₃ has been added, or glass ceramics.

As the polymer solid electrolyte, for example, a compound of a polymer compound and a lithium salt can be used. The polymer compound may have an ethylene oxide structure. Since the polymer electrolyte having an ethylene oxide structure can include a large amount of lithium salt, the ionic conductivity can be further increased. As the lithium salt, LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), or LiC(SO₂CF₃)₃ may be used. One lithium salt selected from these can be used alone. Alternatively, a mixture of two or more lithium salts selected from these may be used.

As the complex hydride solid electrolyte, for example, LiBH₄-Lil, LiBH₄—P₂S₅ or the like can be used.

The electrolyte layer 202 may include a solid electrolyte as a main component. That is, the electrolyte layer 202 may include a solid electrolyte at a mass ratio of 50% or more (50% by mass or more) relative to the entire electrolyte layer 202.

The electrolyte layer 202 may include the solid electrolyte at a mass ratio of 70% or more (70% by mass or more) relative to the entire electrolyte layer 202.

The electrolyte layer 202 may further include inevitable impurities. The electrolyte layer 202 may include a starting material used for synthesis of the solid electrolyte material. The electrolyte layer 202 may include by-products or decomposition products generated at the time of synthesizing the solid electrolyte material.

The mass ratio of the solid electrolyte material included in the electrolyte layer 202 to the electrolyte layer 202 may be substantially 1. The expression “the mass ratio is substantially 1” means that the mass ratio calculated without considering the inevitable impurities that may be included in the electrolyte layer 202 is 1. In other words, the electrolyte layer 202 may be composed only of a solid electrolyte material.

Note that the electrolyte layer 202 may include two or more kinds of the materials listed as the solid electrolytes.

The electrolyte layer 202 may have a thickness of 1 μm or more and 300 μm or less.

In a case where the thickness of electrolyte layer 202 is 1 μm or more, the risk of short circuit between the positive electrode 203 and the negative electrode 201 is reduced. In a case where the thickness of the electrolyte layer 202 is 300 μm or less, the battery 2000 can easily operate at high output.

The positive electrode 203 includes a material that has a property of occluding and releasing metal ions (for example, lithium ions). The positive electrode 203 may include, for example, a positive electrode active material.

Examples of the positive electrode active material include the following (i) to (vii):
(i) lithium-containing transition metal oxides such as Li(NiCoAl)O₂, Li(NiCoMn)O₂, LiCOO₂ or the like,
(ii) transition metal fluorides,
(iii) polyanionic materials,
(iv) fluorinated polyanion materials,
(v) transition metal sulfides,
(vi) transition metal oxysulfides, and
(vii) transition metal oxynitrides. In particular, in a case where a lithium-containing transition metal oxide is used as the positive electrode active material, the cost for producing the battery 2000 can be reduced and the average discharge voltage of the battery 2000 can be increased.

The positive electrode 203 may include a solid electrolyte material. According to the configuration, lithium ion conductivity inside the positive electrode 203 is enhanced to allow the operation at a high output.

Examples of the solid electrolyte material included in the positive electrode 203 may include a halide solid electrolyte, a sulfide solid electrolyte, an oxide solid electrolyte, a polymer solid electrolyte, and a complex hydride solid electrolyte. As the halide solid electrolyte, for example, the materials exemplified above as the first solid electrolyte 101 or the second solid electrolyte 102 may be used. As the sulfide solid electrolyte, the oxide solid electrolyte, the polymer solid electrolyte and complex hydride solid electrolyte, for example, the materials exemplified above as the solid electrolyte included in the electrolyte layer 202 may be used.

The positive electrode active material may be shaped particulate. The positive electrode active material may have an average particle diameter of 0.1 μm or more and 100 μm or less. In a case where the average particle diameter of the positive electrode active material is 0.1 μm or more, the positive electrode active material and the solid electrolyte positive can form a favorable dispersion state in the electrode 203. This improves the charge/discharge characteristic of the battery 2000. In a case where the average particle diameter of the positive electrode active material is 100 μm or less, the lithium diffusion rate within the positive electrode active material is improved. This allows the battery 2000 to operate at high output.

The solid electrolyte included in the positive electrode 203 may have a particulate shape. In the positive electrode 203, the average particle size of the positive electrode active material may be larger than the average particle size of the solid electrolyte.

Thereby, a favorable dispersion state of the positive electrode active material and the solid electrolyte can be formed.

In the positive electrode 203, a volume ratio Vp representing a volume of the positive electrode active material to a sum of the volume of the positive electrode active material and a volume of the solid electrolyte may be 0.3 or more and 0.95 or less. In a case where the volume ratio Vp is 0.3 or more, a sufficient energy density of the battery 2000 can be ensured. In a case where the volume ratio Vp is 0.95 or less, the battery 2000 can operate at a high output.

The positive electrode 203 is a stratum, for example. The positive electrode 203 may have a thickness of 10 μm or more and 500 μm or less. In a case where the thickness of positive electrode 203 is 10 μm or more, sufficient energy density for the battery 2000 can be ensured. In a case where the thickness of the positive electrode 203 is 500 μm or less, the battery 2000 can operate at high output.

The positive electrode active material may be coated with the coating material.

As the coating material, a material having low electronic conductivity may be used. As the coating material, an oxide material, an oxide solid electrolyte or the like can be used.

As the oxide material, for example, SiO₂, Al₂O₃, TiO₂, B₂O₃, Nb₂O₅, WO₃, ZrO₂ or the like may be used.

As the oxide solid electrolyte, for example, any of the following (i) to (x) can be used:
(i) Li—Nb—O compounds such as LiNbO₃,
(ii) Li—B—O compounds such as LiBO₂ or Li₃BO₃,
(iii) Li—Al—O compounds such as LiAlO₂,
(iv) Li—Si—O compounds such as Li₄SiO₄,
(v) Li—S—O compounds such as Li₂SO₄,
(vi) Li—Ti—O compounds such as Li₄Ti₅O₁₂,
(vii) Li—Zr—O compounds such as Li₂ZrO₃,
(viii) Li—Mo—O compounds such as Li₂MoO₃,
(ix) Li—V—O compounds such as LiV₂O₅, and
(x) Li—W—O compounds such as Li₂WO₄.

The oxide solid electrolyte has high ionic conductivity and high potential stability.

For this reason, the charge/discharge efficiency can be further improved by using an oxide solid electrolyte.

At least one selected from the group consisting of the positive electrode 203 and the electrolyte layer 202 may contain a binder for the purpose of improving adhesion between particles. As the binder, for example, the binder mentioned above for the electrode material 1000 may be used.

The positive electrode 203 may include a conductive additive for the purpose of increasing electrical conductivity. As the conductive additive, for example, the one mentioned above for the electrode material 1000 may be used.

An example of the shape of the battery 2000 is a coin, a cylinder, a prism, a sheet, a button, a flat type, a stacking structure or the like.

### EXAMPLES

Hereinafter, details of the present disclosure will be described with reference to Inventive Example and Comparative Examples. The electrode materials and batteries of the present disclosure are not limited to the following Inventive Example.

### Inventive Example 1

### (Production of First Solid Electrolyte)

Under a dry argon atmosphere, raw material powders of LiBr, YBr₃, LiCl, YCl₃, Lil, and Yl₃ were weighed so that the molar ratio was Li:Y:Cl:Br:I=3:1:2:2:2. These powders were ground and mixed in a mortar. Subsequently, milling processing was performed at 600 rpm for 25 hours using a planetary ball mill. Thereby, a powder of the solid electrolyte Li₃YBr₂Cl₂I₂ was obtained.

### (Production of Second Solid Electrolyte)

Under a dry argon atmosphere, raw material powders of LiBr, YBr₃, LiCl, and YCl₃ were weighed so that the molar ratio was Li:Y:Br:Cl=3:1:2:4. These were ground and mixed in a mortar. Subsequently, milling processing was performed at 600 rpm for 25 hours using a planetary ball mill. Thereby, a powder of the solid electrolyte Li₃YBr₂Cl₄ was obtained.

### (Production of Electrode)

The first solid electrolyte and the second solid electrolyte were weighed so that the volume ratio R1 of the first solid electrolyte to a sum of the volume of the first solid electrolyte and the volume of the second solid electrolyte was 25%. The total mass of the first solid electrolyte and the second solid electrolyte was 2.8 g. Next, 0.9 g of a parachlorotoluene solution including a styrene-ethylene/butylene-styrene block copolymer (SEBS) (Tuftec (registered trademark) manufactured by Asahi Kasei Corporation) at a concentration of 6% by mass and 3 g of tetralin were added to the mixture of the first solid electrolyte and the second solid electrolyte, and mixed for 5 minutes at 1600 rpm using an autorotation mixerAwatori Rentaro (ARE-310 manufactured by THINKY CORPORATION). To the obtained mixture, 0.05 g of vapor-grown carbon fiber (VGCF (registered trademark)) and 3.2 g of Li₄Ti₅O₁₂ (manufactured by TOSHIMA Manufacturing Co., Ltd.) as an active material were further added, and the mixture was mixed for 5 minutes at 1600 rpm using an autorotation mixer Awatori Rentaro (ARE-310 manufactured by THINKY CORPORATION). Next, the obtained mixture was subjected to a dispersion treatment for 30 minutes using an ultrasonic dispersion machine, and a further dispersion treatment was performed for 10 minutes at 3000 rpm using a homogenizer (HG-200 manufactured by AS ONE Corporation). Next, the prepared slurry was coated onto the Al foil, using an applicator. The resulting coating film was dried at 40° C., and then further dried at 120° C. for 40 minutes. As a result, an electrode formed of the electrode material was produced.

The cross section of the obtained electrode was observed with a SEM, and the first solid electrolyte and the second solid electrolyte were identified by the method described above. As a result, the volume ratio R1 was 25%. (Production of impedance measurement sample) In an insulating outer cylinder, 80 mg of Li₅PS₆Cl was temporarily press-molded at a pressure of 4 MPa, and punched electrodes were stacked on both surfaces of the molded body. The thus obtained stacked body was press-molded at a pressure of 360 MPa to produce a stacked body formed of a first electrode, a second electrode, and an electrolyte layer sandwiched between the first electrode and the second electrode. Next, current collectors made of stainless steel were disposed on the upper and lower parts of the stacked body, and current collection leads were attached to the current collectors. Finally, the interior of the insulating outer cylinder was isolated from the outside atmosphere by using an insulating ferrule, and the interior of the insulating outer cylinder was sealed, thereby producing the stacked body of Inventive Example 1.

### (Impedance Measurement)

Impedance measurement was performed using a sample for impedance measurement. The ionic conductivity at room temperature was measured using electrochemical impedance measurement in which the sample was connected to a potentiostat (VersaSTAT4 manufactured by Princeton Applied Research) equipped with a frequency response analyzer. Table 1 shows the measured effective ionic conductivity of Inventive Example 1.

### Comparative Example 1

An electrode of Comparative Example 1 was produced by the same method as Inventive Example 1, except that the electrode was produced without using the first solid electrolyte. The effective ionic conductivity of the electrode produced in Comparative Example 1 was measured by the same method as in Inventive Example 1. The results are shown in Table 1.

### Comparative Example 2

An electrode of Comparative Example 2 was produced by the same method as Inventive Example 1, except that the first solid electrolyte and the second solid electrolyte were weighed so that the volume ratio R1 was 50%. The effective ionic conductivity of the electrode produced in Comparative Example 2 was measured by the same method as in Inventive Example 1. The results are shown in Table 1.

### Comparative Example 3

An electrode of Comparative Example 3 was produced by the same method as Inventive Example 1, except that the first solid electrolyte and the second solid electrolyte were weighed so that the volume ratio R1 was 75%. The effective ionic conductivity of the electrode produced in Comparative Example 3 was measured by the same method as in Inventive Example 1. The results are shown in Table 1.

### Comparative Example 4

An electrode of Comparative Example 4 was produced by the same method as Inventive Example 1, except that the electrode was produced without using the second solid electrolyte. The effective ionic conductivity of the electrode produced in Comparative Example 4 was measured by the same method as in Inventive Example 1. The results are shown in Table 1.

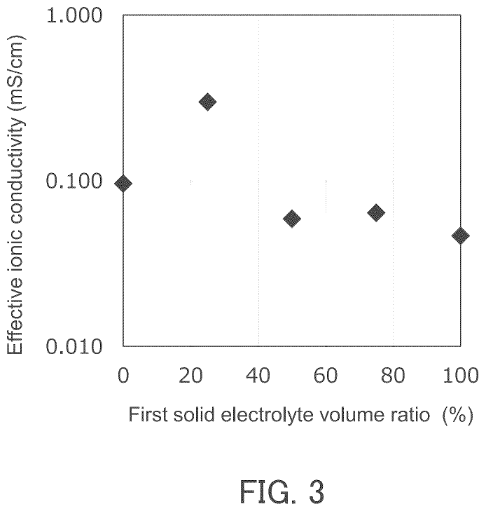

FIG. 3 is a graph showing the relationship between the volume ratio R1 of the first solid electrolyte and the effective ionic conductivity of the electrode for Inventive Example and Comparative Examples.

TABLE 1

| | | | First solid | Effective |
|---|---|---|---|---|
| | | | electrolyte | ionic |
| | First solid | Second solid | volume | conductivity |
| | electrolyte | electrolyte | ratio R1 (%) | (mS/cm) |
| Inventive | LYBCI | LYBC | 25 | 0.30 |
| Example 1 | | | | |
| Comparative | — | LYBC | 0 | 0.10 |
| Example 1 | | | | |
| Comparative | LYBCI | LYBC | 50 | 0.06 |
| Example 2 | | | | |
| Comparative | LYBCI | LYBC | 75 | 0.06 |
| Example 3 | | | | |
| Comparative | LYBCI | — | 100 | 0.05 |
| Example 4 | | | | |

### [Consideration]

As can be seen from Table 1 and FIG. 3, when an electrode was formed of an electrode material including a first solid electrolyte and a second solid electrolyte so that a volume ratio R1 representing a volume of the first solid electrolyte to a sum of the volume of the first solid electrolyte and a volume of the second solid electrolyte was 1% or more and 49% or less, its effective ionic conductivity was improved. This is presumed to be due to the high ionic conductivity of the first solid electrolyte alone and its good compatibility with the binder of the second solid electrolyte. Furthermore, it has been confirmed from the results of Inventive Example 1 that the first solid electrolyte and the second solid electrolyte may be mixed in a volume ratio of “first solid electrolyte”: “second solid electrolyte”=1:3 in order to produce an electrode with high effective ionic conductivity.

### INDUSTRIAL APPLICABILITY

The electrode material of the present disclosure can be used, for example, in all-solid-state lithium ion secondary batteries. According to the electrode material of the present disclosure, decline in ionic conductivity due to the binder in the electrode can be minimized. An electrode including the electrode material of the present disclosure is capable of improving effective ionic conductivity.

What is claimed is:

1. An electrode material comprising:
an active material;
a first solid electrolyte; and
a second solid electrolyte,
wherein the first solid electrolyte includes I,
the second solid electrolyte is free of I, and
a ratio of a volume of the first solid electrolyte to a sum of the volume of the first solid electrolyte and a volume of the second solid electrolyte is 1% or more and 49% or less.

2. The electrode material according to claim 1, wherein the ratio is 20% or more and 30% or less.

3. The electrode material according to claim 1, wherein
the first solid electrolyte comprises a compound represented by a composition formula (1) bellow:
Li_{α1}M1_{β1}X1_{γ1}|_{δ1} Formula (1)
where
α1 satisfies 0<α1,
β1 satisfies 0<β1,
γ1 satisfies 0≤γ1,
δ1 satisfies 0<1,
M1 includes at least one selected from the group consisting of metalloid elements and metal elements other than Li, and
X1 includes at least one selected from the group consisting of F, Cl, and Br.

4. The electrode material according to claim 3, wherein the M1 includes Y.

5. The electrode material according to claim 4, wherein
the first solid electrolyte comprises a compound represented by a composition formula (1A) below:
Li_{α1}Y_{β1}Br_{γ1a}Cl_{γ1b}|_{δ1} Formula (1A)
where
α1 satisfies 2.5≤α1≤3.5,
β1 satisfies 0.5≤β1≤1.5,
γ1a satisfies 0≤γ1a<6,
γ1b satisfies 0≤γ1b<6,
δ1 satisfies 0<δ1<6, and
γ1a+γ1b+b1=6 is satisfied.

6. The electrode material according to claim 5, wherein in the composition formula (1A),
a1=3, P1=1, 0<γ1a<6, 0<γ1b<6, and, 0<51<6 are satisfied.

7. The electrode material according to claim 1, wherein the second solid electrolyte comprises a compound represented by a composition formula (2) below:
Li_{α2}M2_{β2}X2_{γ2} Formula (2)
where
α2 satisfies 0<α2,
β2 satisfies 0<β2,
γ2 satisfied 0<γ2,
M2 includes at least one selected from the group consisting of metalloid elements and metal elements other than Li, and
X2 includes at least one selected from the group consisting of F, Cl, and Br.

8. The electrode material according to claim 7, wherein the M2 includes Y.

9. The electrode material according to claim 8, wherein the second solid electrolyte comprises a compound represented by a composition formula (2A) below:
Li_{α2}Y_{β2}Br_{γ2a}Cl_{γ2b} Formula (2A)
where
α2 satisfies 2.5≤α2≤3.5,
β2 satisfies 0.5≤β2≤1.5,
γ2a satisfies 0≤γ2a<6,
γ2b satisfies 0≤γ2b<6, and
γ2a+γ2b=6 is satisfied.

10. The electrode material according to claim 9, wherein in the composition formula (2A),
α2=3, β2=1, 0<γ2a<6, and, 0<γ2b<6 are satisfied.

11. The electrode material according to claim 1, further comprising a binder.

12. The electrode material according to claim 11, wherein the binder comprises a polymer.

13. The electrode material according to claim 12, wherein the polymer includes a thermoplastic elastomer.

14. A battery comprising:
a first electrode;
a second electrode; and
an electrolyte layer located between the first electrode and the second electrode, wherein the first electrode comprises the electrode material according to claim 1.

15. The battery according to claim 14, wherein the electrolyte layer comprises a solid electrolyte.

16. The battery according to claim 14, wherein the active material included in the first electrode includes lithium titanate.

17. The battery according to claim 14, wherein
the first electrode is a negative electrode, and
the second electrode is a positive electrode.

18. An electrode comprising:
an active material;
a first solid electrolyte; and
a second solid electrolyte,
wherein the first solid electrolyte includes I,
the second solid electrolyte is free of I, and
a ratio of an area of the first solid electrolyte to a sum of the area of the first solid electrolyte and an area of the second solid electrolyte in a cross section of the electrode is 1% or more and 49% or less.

19. The electrode according to claim 18, wherein the ratio is 20% or more and 30% or less.

20. A battery comprising:
a first electrode;
a second electrode; and
an electrolyte layer located between the first electrode and the second electrode wherein the first electrode is the electrode according to claim 18.
